(19) United States
(12) Patent Application Publication
(10) Pub. No.: US 2026/0210483 A1
(43) Pub. Date: Jul. 23, 2026

(54) AUTOMATIC LEVELING METHOD FOR GIMBAL, AND GIMBAL

(71) Applicant: SHENZHEN LEQI INNOVATION CO., LTD., SHENZHEN (CN)

(72) Inventor: WEI TANG, SHENZHEN (CN)

(21) Appl. No.: 19/450,758

(22) Filed: Jan. 16, 2026

(30) Foreign Application Priority Data
Jan. 17, 2025 (CN) 202510078233.1

(51) Int. Cl. F16M 11/04; F16M 11/10; F16M 11/18; G03B 17/56

(52) U.S. Cl. CPC F16M 11/048; F16M 11/10; F16M 11/18; G03B 17/561; F16M 2200/027

(57) ABSTRACT

The present disclosure provides an automatic leveling method for a gimbal, and a gimbal. The gimbal includes a mounting assembly for mounting a photographic device and a driving assembly connected to the mounting assembly and configured for driving the mounting assembly to move. The method includes: obtaining a center of gravity of the photographic device and determining whether the center of gravity of the photographic device is in an unbalanced position in response to that the photographic device is mounted on the mounting assembly; generating a control signal for adjusting the center of gravity of the photographic device in case the center of gravity of the photographic device is in the unbalanced position; and controlling the driving assembly to operate according to the control signal to drive the mounting assembly to move until the photographic device reaches a center-of-gravity balance position.

### CROSS-REFERENCE TO RELATED APPLICATION

This application is based on and claims priority to China Patent Application No. 202510078233.1, filed on Jan. 17, 2025, the entire contents of which are incorporated herein by reference.

### FIELD

The present disclosure relates to the technical field of gimbals, especially relates to an automatic leveling method for a gimbal, and a gimbal.

### BACKGROUND

A gimbal is a device used to carry photographic device, such as mobile phone or camera. The photographic device is typically mounted onto the gimbal by using auxiliary mounting tools, such as a quick-release plate or a cage. Before using, the gimbal must be leveled. If the gimbal is put into use without proper leveling, the motors within the gimbal will continuously output current to provide unbalanced torque. This not only leads to energy loss and affects motor longevity, but also compromises shooting stability.

However, gimbal leveling methods in related art primarily rely on the operator's tactile sense and experience. The operator needs to subjectively perceive the balance state of each axis of the gimbal. In practice, this often requires repeatedly manually adjusting the joints and angles of the gimbal and continuously attempting to approximate the ideal balanced position. This approach not only demands a high level of skill and proficiency from the operator but also makes it difficult even for experienced professionals to ensure precise leveling of the gimbal within a short time. As a result, the operation of leveling becomes lengthy and cumbersome, significantly hindering the efficient execution of shooting tasks.

### SUMMARY

The main purpose of the present disclosure is to propose an automatic leveling method for a gimbal, and a gimbal, aiming to solve the technical problem that leveling operation for the gimbals in related art is cumbersome, time-consuming and labor-intensive.

To achieve the above purpose, the present disclosure proposes an automatic leveling method for a gimbal. The the gimbal includes a mounting assembly for mounting a photographic device and a driving assembly connected to the mounting assembly and configured for driving the mounting assembly to move, and the method includes:
obtaining a center of gravity of the photographic device and determining whether the center of gravity of the photographic device is in an unbalanced position in response to that the photographic device is mounted on the mounting assembly;
generating a control signal for adjusting the center of gravity of the photographic device in case the center of gravity of the photographic device is in the unbalanced position; and
controlling the driving assembly to operate according to the control signal to drive the mounting assembly to move until the photographic device reaches a center-of-gravity balance position.

In some embodiments, the mounting assembly includes a mounting base and a carrying base connected to the mounting base and configured to carry the photographic device; the driving assembly is arranged between the mounting base and the carrying base and configured to drive the carrying base to move horizontally relative to the mounting base;. The operation “controlling the driving assembly to operate according to the control signal to drive the mounting assembly to move until the photographic device reaches a center-of-gravity balance position” includes:
controlling the driving assembly to operate according to the control signal to drive the carrying base to move forward and backward until the photographic device reaches the center-of-gravity balance position.

In some embodiments, the operation “controlling the driving assembly to operate according to the control signal to drive the carrying base to move forward and backward until the photographic device reaches the center-of-gravity balance position” includes:
in case the center of gravity of the photographic device tilts forward, controlling the driving assembly to operate according to the control signal to drive the carrying base to move backward until the photographic device reaches the center-of-gravity balance position; and
in case the center of gravity of the photographic device tilts backward, controlling the driving assembly to operate according to the control signal to drive the carrying base to move forward until the photographic device reaches the center-of-gravity balance position.

In some embodiments, the gimbal further includes a locking assembly for locking the carrying base with the mounting base, and the method further includes:
controlling the locking assembly to operate to lock the carrying base with the mounting base after the photographic device reaches the center-of-gravity balance position.

In some embodiments, the gimbal further includes: a support frame connected to the mounting assembly and a movable frame movably connected to the support frame. The operation “obtaining the center of gravity of the photographic device and determining whether the center of gravity of the photographic device is in the unbalanced position” includes:
obtaining a tilt angle of the movable frame relative to the support frame, and determining whether the tilt angle is within a preset tilt angle range; and
determining a center-of-gravity offset direction of the photographic device according to the tilt angle in response to that the tilt angle exceeds the preset tilt angle range, and generating a control signal containing the determination.

In some embodiments, the gimbal further includes an angle adjustment assembly for driving the movable frame to rotate; and the method further includes:
obtaining the center of gravity of the gimbal when no photographic device is mounted on the mounting assembly; and
generating a signal to control an operation of the angle adjustment assembly in case the center of gravity of the gimbal is in the unbalanced position until the gimbal reaches the center-of-gravity balance position.

In some embodiments, the gimbal includes a wireless communication unit; before performing the operation “obtaining the center of gravity of the photographic device and determining whether the center of gravity of the photographic device is in an unbalanced position”, the method further includes:
receiving a wireless control signal, and controlling the driving assembly, the locking assembly, and the angle adjustment assembly to enter a standby state according to the wireless control signal.

In some embodiments, after the operation “generating a signal to control an operation of the angle adjustment assembly in case the center of gravity of the gimbal is in the unbalanced position until the gimbal reaches the center-of-gravity balance position”, the method further includes:
sending an adjustment result of the center of gravity of the photographic device and/or the center of gravity of the gimbal to control system.

The present disclosure further provides a gimbal, which includes: a control device; a mounting assembly configured for mounting a photographic device; and a driving assembly connected to the mounting assembly and configured for driving the mounting assembly to move; the control device includes a memory having computer-executable instructions stored thereon, and a processor coupled to the memory and configured to execute the computer-executable instructions to implement operations of the automatic leveling method for the gimbal.

In some embodiments, the mounting assembly includes: a mounting base; and a carrying base connected to the mounting base and configured for carrying the photographic device; the driving assembly is arranged between the mounting base and the carrying base for driving the carrying base to move horizontally relative to the mounting base.

In some embodiments, the carrying base and the mounting base are connected by way of a horizontal plug-in structure; the driving assembly and the carrying base are connected by way of a rack-and-pinion transmission structure.

In some embodiments, the gimbal further includes: a locking assembly configured for locking the carrying base with the mounting base.

In some embodiments, the gimbal further includes: a support frame connected to the mounting assembly; and a movable frame movably connected to the support frame; the gimbal further includes an angle adjustment assembly configured to drive the movable frame to rotate.

In the technical solution of the present disclosure, when the photographic device is mounted on the mounting assembly, the center of gravity of the photographic device is obtained and it is determined whether the center of gravity of the photographic device is in an unbalanced position. In case the center of gravity of the photographic device is in the unbalanced position, a control signal for adjusting the center of gravity of the photographic device is generated, and based on the control signal, the driving assembly is controlled to operate to drive the mounting assembly to move until the photographic device is in the center-of-gravity balance position. This realizes automatic leveling of the gimbal. Compared with the leveling method in related art that relies on the operator's manual feel and experience, the automatic leveling method of the present disclosure can quickly detect and adjust the photographic device to the balanced center-of-gravity position, which lowers the operation threshold, has high leveling precision, and improves the efficiency of preparation of the gimbal.

### BRIEF DESCRIPTION OF THE DRAWINGS

Implementations of the present disclosure will now be described, by way of embodiment, with reference to the attached FIG.s. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a structural diagram of a gimbal according to an embodiment of the present disclosure.

FIG. 2 is a flow diagram of the automatic leveling method for the gimbal according to an embodiment of the present disclosure.

FIG. 3 is a diagram of a partial structure of the gimbal according to an embodiment of the present disclosure.

FIG. 4 is a flow diagram of the automatic leveling method for the gimbal according to an embodiment of the present disclosure.

FIG. 5 is a flow diagram of the automatic leveling method for the gimbal according to an embodiment of the present disclosure.

FIG. 6 is a flow diagram of the automatic leveling method for the gimbal according to an embodiment of the present disclosure.

FIG. 7 is a flow diagram of the automatic leveling method for the gimbal according to an embodiment of the present disclosure.

FIG. 8 is a flow diagram of the automatic leveling method for the gimbal according to an embodiment of the present disclosure.

FIG. 9 is a flow diagram of the automatic leveling method for the gimbal according to an embodiment of the present disclosure.

FIG. 10 is a flow diagram of the automatic leveling method for the gimbal according to an embodiment of the present disclosure.

FIG. 11 is a flow diagram of the automatic leveling method for the gimbal according to an embodiment of the present disclosure.

### REFERENCE NUMERALS

100, gimbal; 10, mounting assembly; 20, driving assembly; 11, mounting base; 12, carrying base; 30, locking assembly; 40, support frame; 50, movable frame; 60, angle adjustment assembly; 70, horizontal plug-in structure; 80, rack-and-pinion transmission structure.

The realization of the aim, functional characteristics, advantages of the present disclosure are further described specifically with reference to the accompanying drawings and embodiments.

### DETAILED DESCRIPTION

The embodiments of the present disclosure will be described clearly and completely below with reference to the accompanying drawings. Obviously, the described embodiments are merely some of the embodiments of the present disclosure, rather than all of them. Based on the embodiments of the present disclosure, all other embodiments obtained by those skilled in the art without creative efforts shall fall within the scope of protection of the present disclosure.

It should be noted that all directional indications (such as upper, lower, left, right, front, rear, etc.) in the embodiments of the present disclosure are only used to explain the relative positional relationships, movement states, and the like among various components under a specific orientation (as shown in the accompanying drawings). If the specific orientation changes, the corresponding directional indications shall also change accordingly.

It should also be noted that when an element is referred to as being “fixed to” or “disposed on” another element, it may be directly fixed to or disposed on the another element, or there may be an intervening element present. When an element is referred to as being “connected to” another element, it may be directly connected to the another element, or there may be an intervening element present.

In addition, in the present disclosure, the terms such as “first” and “second” are used for descriptive purposes only and are not intended to indicate or imply relative importance or to implicitly specify the number of the indicated technical features. Accordingly, a feature described as “first” or “second” may explicitly or implicitly include one or more such features. Furthermore, the technical features or technical solutions of the various embodiments may be combined with one another where such combinations are capable of being implemented by a person of ordinary skill in the art. Any combination that would result in inconsistencies or that is not operable should be understood as not being within the scope of the present disclosure.

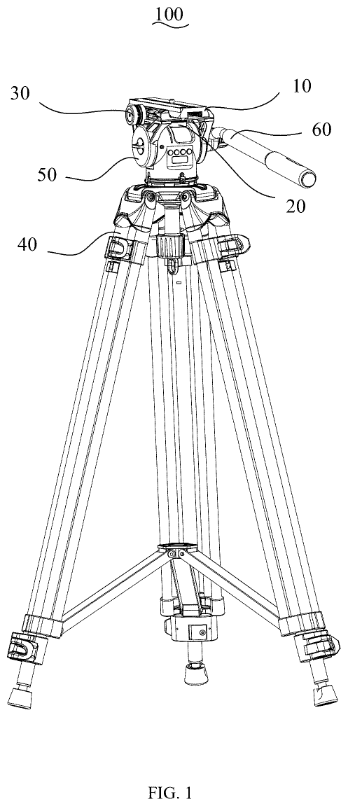

Please referring to FIG. 1, an embodiment of the present disclosure provides a gimbal 100, which includes a mounting assembly 10 for mounting a photographic device and a driving assembly 20 connected to the mounting assembly 10 for driving the mounting assembly 10 to move.

The gimbal 100 involved in the present disclosure is a device for mounting and stabilizing photographic device (such as cameras, video cameras, etc.). Its main function is to provide multi-axis rotation and positioning, enabling the photographic device to flexibly adjust the shooting angle and maintain stability during the shooting process. The gimbal 100 enables motion control in horizontal, vertical, and rolling directions. For example, when taking panoramic photos or tracking moving objects, the smooth rotation of the gimbal 100 in the horizontal direction allows for seamless video recording; when shooting objects at high or low positions, the vertical adjustment capability ensures accurately targeting the subject.

The mounting assembly 10 is mainly configured to mount the photographic device on the gimbal 100. The mounting assembly 10 commonly includes components such as a quick-release plate, screws, and clamps. The quick-release plate allows for convenient mounting and rapid disassembly of the photographic device on the gimbal 100. The design of the clamps varies according to different types of photographing equipment. For instance, the clamps of some gimbals 100 can be adapted to camera bodies or lenses of different sizes, and the width and height of the clamps can be adjusted to ensure secure mounting of the photographic device.

The driving assembly 20 is mainly configured to drive the mounting assembly 10 to move. The driving assembly 20 generally consists of a motor, a transmission mechanism (such as gears, lead screws, etc.), and a control circuit. The motor serves as the power source and operates according to control signals. The transmission mechanism converts the rotational motion of the motor into linear or rotational motion of the mounting assembly 10 in various axes. The control circuit is responsible for receiving and processing control signals to ensure the accurate operation of the driving assembly 20.

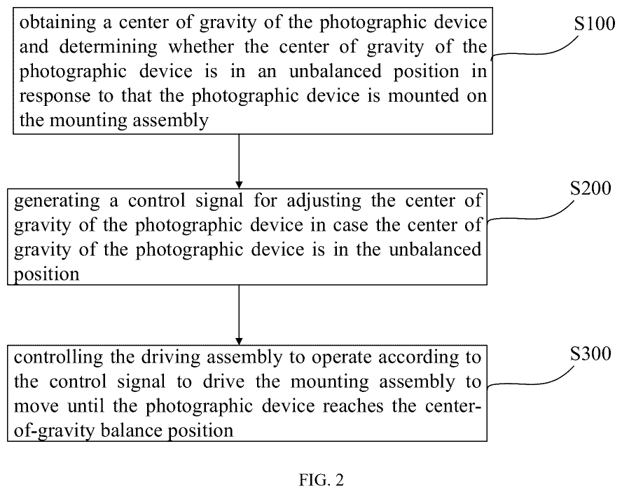

Please referring to FIG. 2, an embodiment of the present disclosure provides an automatic leveling method for the gimbal 100, which includes the following steps:
Step S100, obtaining a center of gravity of the photographic device and determining whether the center of gravity of the photographic device is in an unbalanced position in response to that the photographic device is mounted on the mounting assembly;
Step S200, generating a control signal for adjusting the center of gravity of the photographic device in case the center of gravity of the photographic device is in the unbalanced position; and
Step S300, controlling the driving assembly to operate according to the control signal to drive the mounting assembly to move until the photographic device reaches the center-of-gravity balance position.

Among these steps, Step S100 is configured to obtain the center of gravity of the photographic device and determine whether the center of gravity is in an unbalanced position. When the photographic device is mounted on the mounting assembly 10 of the gimbal 100, the center-of-gravity position of the photographic device can be acquired through a center-of-gravity detection device. Generally, the center-of-gravity detection device may generally employ pressure sensors, angle sensors, or combinations of one or more such sensors. For example, an angle sensor can be installed at the connecting shaft between the mounting assembly 10 and the gimbal 100. When the center of gravity of the photographic device is unbalanced, it will cause the mounting assembly 10 to tilt relative to the gimbal 100, and the angle sensor can measure such a tilt angle. For instance, angle sensor can be installed respectively on the horizontal axis and vertical axis of the gimbal 100. If the angle sensor on the horizontal axis detects that the mounting assembly 10 has a certain tilt angle relative to the horizontal direction (e.g., exceeding 1o), it indicates that the center of gravity of the photographic device is unbalanced in the horizontal direction. Similarly, the angle sensor on the vertical axis can detect the tilt of the mounting assembly 10 in the vertical direction, thereby determining whether the center of gravity of the photographic device is unbalanced in the vertical direction.

Step S200 is configured to generate a control signal for adjusting the center of gravity of the photographic device when the center of gravity is in an unbalanced position. The data from the center-of-gravity detection device can be used to determine the direction or degree of imbalance of the photographic device. For example, the tilt angles of the mounting assembly 10 in the horizontal and vertical directions can be directly obtained through angle sensors. If the angle sensor in the horizontal direction detects that the mounting assembly 10 tilts to the left by a certain angle (e.g., an angle of θ), then the imbalance direction is horizontal leftward; if the angle sensor in the horizontal direction detects that the mounting assembly 10 tilts to the right by a certain angle (e.g., an angle of −θ), then the imbalance direction is horizontal rightward.

Further, parameters such as the movement direction and speed of the driving assembly 20 are determined based on the imbalance direction or degree of the photographic device, and corresponding control signals are then generated, which may be electrical or digital signals. If the imbalance direction is horizontal leftward, a control signal is generated to drive the mounting assembly 10 to move horizontally rightward, ensuring that the mounting assembly 10 shifts to a proper position and restores the center-of-gravity balance of the photographic device.

Step S300 is configured to adjust the photographic device to the center-of-gravity balance position. In case the control signal indicates that the mounting assembly 10 need to move in the horizontal direction, the driving assembly 20 will drive the mounting assembly 10 to move, thereby driving the photographic device to move and gradually adjusting its position until the center of gravity of the photographic device reaches the balanced position.

It should be noted that during the process of adjusting the photographic device to its center-of-gravity balance position, multiple adjustments may be required until the center of gravity of the photographic device reaches the balanced position. Throughout the adjustment process, the control signal needs to be continuously optimized according to the actual conditions of the photographic device and the changes in the center-of-gravity position after each adjustment. For example, through multiple adjustments, the center of gravity of the photographic device gradually approaches the balanced position and finally achieves a stable balanced state. This enables more accurate determination of the center-of-gravity position of the photographic device, thereby ensuring that the photographic device remains balanced during shooting.

In the present disclosure, in case the photographic device is mounted on the mounting assembly 10, the center of gravity of the photographic device is obtained and whether the center of gravity is in an unbalanced position is determined. If the center of gravity of the photographic device is in an unbalanced position, a control signal is generated to adjust the center of gravity, then the driving assembly 20 is controlled to drive the mounting assembly 10 to move until the photographic device reaches the center-of-gravity balance position, thereby realizing the automatic leveling of the gimbal 100. Compared with the leveling method in related art that relies on the operator's manual feel and experience, the automatic leveling method for the gimbal 100 of the present disclosure can quickly detect and adjust the photographic device to the center-of-gravity balance position, which lowers operation threshold, achieves high leveling precision, and improves the efficiency of the preparation work for the gimbal 100.

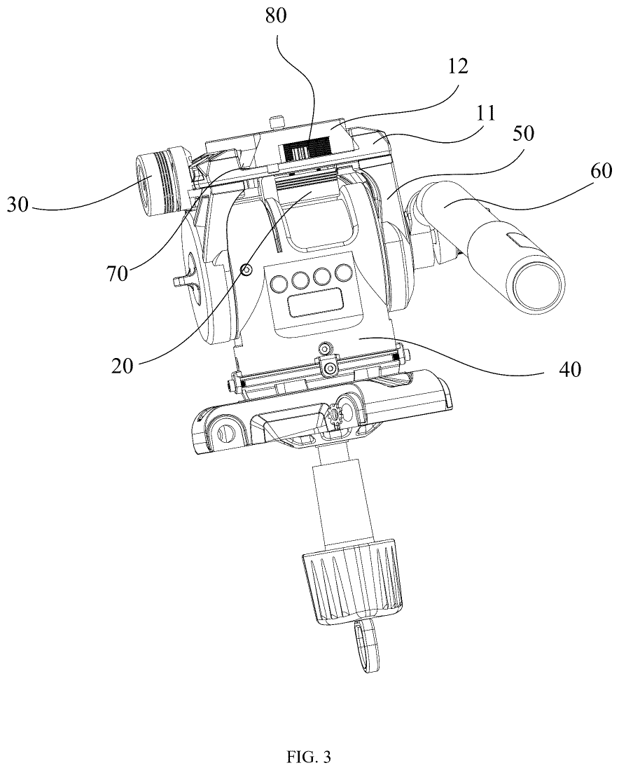

Further, please referring to FIG. 3, the mounting assembly 10 includes a mounting base 11 and a carrying base 12 which is connected to the mounting base 11 and configured for bearing the photographic device. The driving assembly 20 is arranged between the mounting base 11 and the carrying base 12, and is configured to drive the carrying base 12 to move horizontally relative to the mounting base 11.

In this embodiment, a layered design of the mounting base 11 and the carrying base 12 is employed to facilitate the installation and adjustment of the photographic device. The mounting base 11 may serve as a fixed base part to achieve stable connection with other parts of the gimbal 100 (such as supporting feet). The carrying base 12 is specially used for placing the photographic device, and can move horizontally relative to the mounting base 11 by the driving of the driving assembly 20, thus enabling effective fine adjustment of the horizontal position of the photographic device.

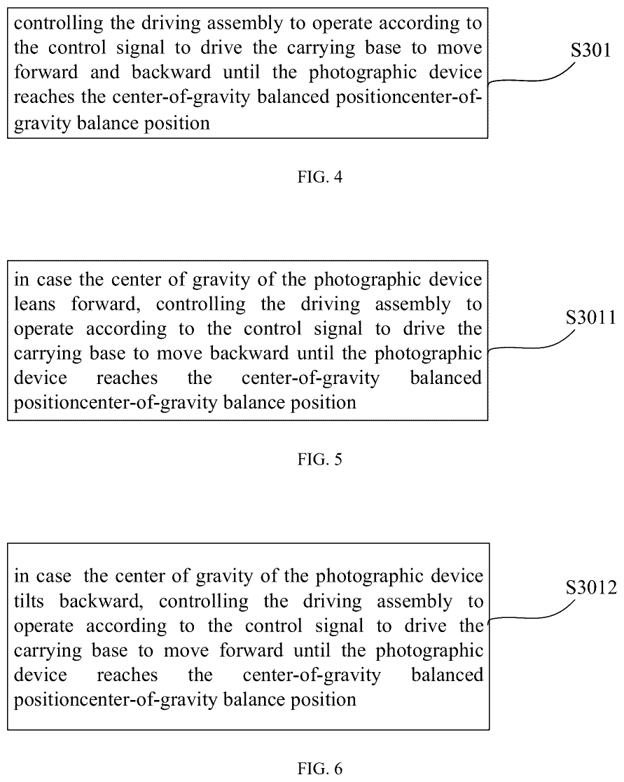

Please referring to FIG. 4, in some embodiments, controlling the driving assembly 20 to drive the mounting assembly 10 to move according to the control signal until the photographic device reaches the center-of-gravity balance position includes the following step:
Step S301, controlling the driving assembly 20 to operate according to the control signal to drive the carrying base 12 to move forward and backward until the photographic device reaches the center-of-gravity balance position.

In this embodiment, a control signal for adjusting the center of gravity of the photographic device is generated when the center of gravity of the photographic device is in an unbalanced position. For example, the center-of-gravity position information of the photographic device is obtained by pressure sensors or angle sensors installed on the mounting assembly 10 or the carrying base 12. If the sensors detect a forward offset of the center of gravity of the photographic device, the control system will calculate parameters such as the distance and speed that the carrying base 12 needs to move backward, and generate corresponding control signals to drive the carrying base 12 to move backward until the photographic device achieves center-of-gravity balance in the forward and backward direction.

The method of achieving center-of-gravity balance by driving the carrying base 12 to move forward and backward enables relatively precise adjustment. Specifically, since the driving assembly 20 can accurately control the moving distance and speed of the carrying base 12, it is capable of fine-tuning the center-of-gravity position of the photographic device. For example, for some photographic devices with extremely high balance requirements, such as cameras equipped with telephoto lenses, fine-tuning the forward and backward movement of the carrying base 12 can minimize the deviation of the center-of-gravity position, thereby ensuring stability during shooting.

Please referring to FIGS. 5 and 6, in some embodiments, controlling the driving assembly 20 to operate according to the control signal to drive the carrying base 12 to move forward and backward until the photographic device reaches the center-of-gravity balance position includes the following steps:
Step S3011, in case the center of gravity of the photographic device leans forward, controlling the driving assembly 20 to operate according to the control signal to drive the carrying base 12 to move backward until the photographic device reaches the center-of-gravity balance position; and
Step S3012, in case the center of gravity of the photographic device tilts backward, controlling the driving assembly 20 to operate according to the control signal to drive the carrying base 12 to move forward until the photographic device reaches the center-of-gravity balance position.

In this embodiment, an angle sensor may be installed at the connection part between the carrying base 12 and the mounting base 11, and the angle sensor can accurately measure the tilt angle of the carrying base 12 in the forward and backward directions. For example, when the angle sensor detects that the forward tilt angle is a positive value and exceeds the set threshold, it is determined as forward tilt; when the backward tilt angle is a negative value and exceeds the set threshold, it is determined as backward tilt. Of course, this is merely exemplary. The definitions of forward tilt and backward tilt can also be defined according to the selected center-of-gravity detection method, and are not limited in the embodiments of the present application.

The photographic device may experience forward or backward center-of-gravity shifts under different installation environments and usage scenarios. For instance, when taking photos at a large tilt angle, the photographic device may exhibit forward center-of-gravity lean; whereas when equipped with a heavy battery or other accessories, the photographic device may show backward center-of-gravity lean. In this embodiment, by detecting the the center-of-gravity tilt direction of the photographic device, corresponding control signals are generated to to drive the carrying base 12 to move in a specific direction via the driving assembly 20, enabling the photographic device to achieve center-of-gravity balance. Therefore, it can meet center-of-gravity balance requirements of the photographic device across various scenarios and improve the stability and shooting quality of the photographic device.

In some embodiments, the gimbal 100 further includes a locking assembly 30, which is configured to lock the carrying base 12 and the mounting base 11 together.

In this embodiment, the locking assembly 30 may employ mechanical structures such as snap-fit locks or locking bolts. Utilizing its own shape and structural characteristics, the locking assembly 30 engages the corresponding parts of the carrying base 12 and the mounting base 11 to form mechanical constraints, limiting the relative movement and rotation between the two, thereby achieving locking. This ensures that there is no relative displacement or loosening between the carrying base 12 and the mounting base 11, so as to keep the shooting position and angle of the photographic device stable, which is conducive to capturing high-quality, shake-free images.

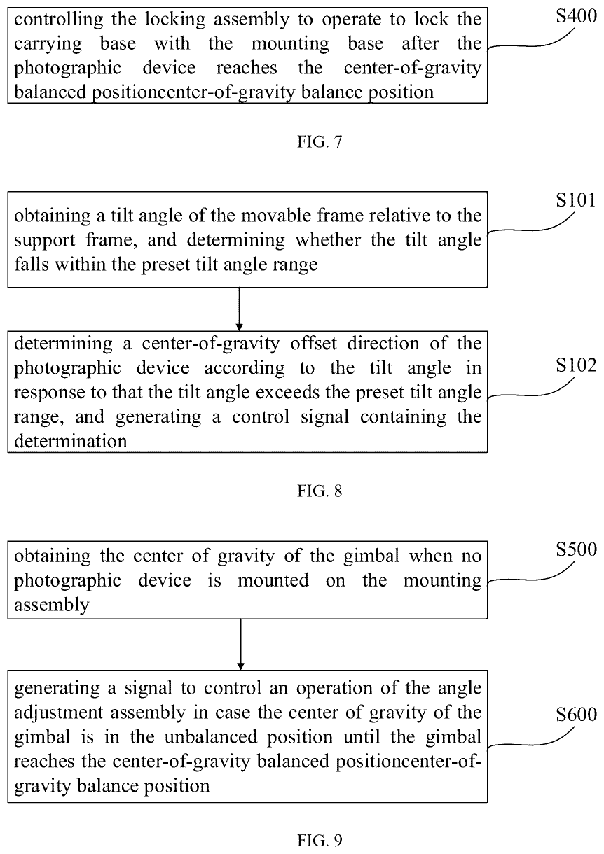

Please referring to FIG. 7, the automatic leveling method further includes the following step:
Step S400, controlling the locking assembly 30 to operate to lock the carrying base 12 with the mounting base 11 after the photographic device reaches the center-of-gravity balance position.

When it is determined that the photographic device has reached the center-of-gravity balance position through the aforementioned automatic leveling steps, this serves as a trigger signal to initiate the control operation of the locking assembly 30. The locking assembly 30 starts to operate upon receiving the control signal. For example, for locking bolts, a motor may drive the nuts to rotate, gradually tightening the bolts to firmly connect the carrying base 12 and the mounting base 11 together. For a snap-fit locking assembly 30, mechanical device may be driven by the control signal to make the snaps accurately engage with the corresponding slots, achieving the locking of the carrying base 12 and the mounting base 11.

Locking the device after the photographic device reaches the center-of-gravity balance position can effectively prevent relative displacement between the carrying base 12 and the mounting base 11 caused by external disturbances (such as slight vibrations, accidental touches, etc.) during shooting, which would otherwise disrupt the center-of-gravity balance of the photographic device. Moreover, after locking the carrying base 12 and the mounting base 11 together, the entire gimbal 100 and the photographic device form a more stable integrated structure. When the gimbal 100 performs various movements (such as horizontal rotation, pitching, etc.), it can better resist the inertial forces and torques generated by the movements, reduce shaking and jitter of the device, and improve the stability of the device under different working conditions.

Furthermore, locking being only engaged after the photographic device achieves center-of-gravity balance avoids unnecessary locking operations during the leveling process, reducing wear on the locking assembly 30 and energy consumption. Meanwhile, it also prevents the situations where premature locking would hinder further leveling adjustments, thereby enhancing the efficiency and reliability of the entire automatic leveling system.

In some embodiments, the gimbal 100 further includes a support frame 40 connected to the mounting assembly 10 and a movable frame 50 movably connected to the support frame 40.

The support frame 40 serves as the basic supporting structure of the gimbal 100. The tight connection between the support frame 40 and the mounting assembly 10 provides stable support for the entire gimbal 100 system. The support frame 40 is generally made of a rigid metal material, such as aluminum alloy or steel, to ensure sufficient strength and stability to bear the weight of the mounting assembly 10, the photographic device, and other related components.

The movable frame 50 is movably connected to the support frame 40, allowing the movable frame 50 to move within a certain range relative to the support frame 40. Common movable connection methods include rotational connection and pivotal connection. Through rotational connection, the movable frame 50 can rotate around a fixed axis to achieve horizontal rotation. Pivotal connection allows the movable frame 50 to swing at a certain angle in multiple directions, increasing the flexibility and adjustability of the gimbal 100.

Please referring to FIG. 8, the step of obtaining the center of gravity of the photographic device and determining whether the center of gravity of the photographic device is in an unbalanced position includes the following steps:
Step S101, obtaining a tilt angle of the movable frame 50 relative to the support frame 40, and determining whether the tilt angle falls within the preset tilt angle range;
Step S102, determining a center-of-gravity offset direction of the photographic device according to the tilt angle in response to that the tilt angle exceeds the preset tilt angle range, and generating a control signal containing the determination.

To obtain the tilt angle of the movable frame 50 relative to the support frame 40 in the gimbal 100, an angle sensor may be installed at the joint between the movable frame 50 and the support frame 40. These angle sensors can be mechanical, electronic, or optical, and are capable of accurately measuring the tilt degree of the movable frame 50 relative to the support frame 40 in all directions. For example, a common electronic gyroscope sensor can real-time detect the angular changes of the movable frame 50 and convert such information into electrical signals for output. The tilt angle of the movable frame 50 relative to the support frame 40 can be obtained by processing and interpreting these electrical signals.

The preset tilt angle range is determined according to the design requirements of the gimbal 100 and the characteristics of the photographic device, intending to ensure that the photographic device can maintain center-of-gravity balance within a certain tilt range, thereby guaranteeing shooting stability. For instance, for some professional gimbals 100 with high precision requirements, the preset tilt angle range may be set relatively narrow, such as ±1o; while for some simple gimbals 100, this range may be appropriately widened, such as ±3o. The determination of the preset tilt angle range needs to comprehensively consider based on various factors, including the load-bearing capacity of the gimbal 100 and the weight and center-of-gravity distribution of the photographic device, and shall be set according to actual conditions.

The obtained tilt angle of the movable frame 50 relative to the support frame 40 is compared with the preset tilt angle range. If the tilt angle is within the preset range, it indicates that the center of gravity of the photographic device is in a balanced position, then the gimbal 100 does not need to perform additional adjustments at this time. If the tilt angle exceeds the preset range, it is necessary to further determine the direction of the center-of-gravity offset of the photographic device and take corresponding adjustment measures.

Further, in case the tilt angle exceeds the preset tilt angle range, the direction of the center-of-gravity offset of the photographic device is determined according to the value and direction of the tilt angle. For example, if the forward tilt angle of the movable frame 50 exceeds the preset range, it can be inferred that the center of gravity of the photographic device shifts forward; if the leftward tilt angle of the movable frame 50 exceeds the preset range, the center of gravity of the photographic device may shift leftward. Based on the determination of the center-of-gravity offset direction, a control signal containing the determination is generated. This control signal will serve as the basis for subsequent adjustments of the gimbal 100 and the photographic device. The control signal can contain various types of information, such as the direction of the center-of-gravity offset (forward, backward, leftward, rightward, etc.) and the degree of offset (reflected by the magnitude of the tilt angle). The control signal can be in the form of digital signals, analog signals, or other specific signal formats.

The generated control signal will be transmitted to the control system of the gimbal 100. According to the control signal, the control system activates corresponding adjustment mechanism. For example, if the control signal indicates that the center of gravity of the photographic device shifts forward, the control system will send an instruction to the driving assembly 20 to drive the carrying base 12 to move backward, so as to adjust the center-of-gravity position of the photographic device; if the center of gravity shifts leftward, the control system will control the driving assembly 20 to move the carrying base 12 rightward. In this way, precise adjustment of the center of gravity of the photographic device is achieved, ensuring that the photographic device is always in the center-of-gravity balance position, thereby improving shooting stability and quality.

Please referring to FIG. 9, in some embodiments, the gimbal 100 further includes an angle adjustment assembly 60 configured to drive the movable frame 50 to rotate, and the automatic leveling method further includes the following steps:
Step S500, obtaining the center of gravity of the gimbal 100 when no photographic device is mounted on the mounting assembly 10;
Step S600, generating a signal to control an operation of the angle adjustment assembly 60 in case the center of gravity of the gimbal 100 is in the unbalanced position until the gimbal 100 reaches the center-of-gravity balance position.

When no photographic device is mounted on the mounting assembly 10, the center-of-gravity state of the gimbal 100 is mainly determined by its own components such as the support frame 40, the movable frame 50, and the angle adjustment assembly 60. To obtain the center of gravity of the gimbal 100, high-precision pressure sensors may be installed at key positions of the gimbal 100 (e.g., the bottom of the support frame 40, the connection points of the movable frame 50, etc.). These sensors are capable of measuring the pressure borne at each position. According to mechanical principles, the center-of-gravity position of the gimbal 100 can be derived through the analysis and calculation of such pressure data.

The acquired center-of-gravity position of the gimbal 100 is compared with the preset balance position. If the center of gravity of the gimbal 100 is outside this preset balance position, it is determined that the center of gravity of the gimbal 100 is in an unbalanced state. Upon determining that the center of gravity of the gimbal 100 is unbalanced, the control system will generate a signal for controlling the operation of the angle adjustment assembly 60 based on the direction and degree of the center-of-gravity imbalance. This signal will contain detailed instruction information, such as the rotation direction (clockwise or counterclockwise) and the rotation angle required for the angle adjustment assembly 60, to ensure effective adjustment of the center of gravity of the gimbal 100.

The angle adjustment assembly 60 starts to operate upon receiving the control signal. The angle adjustment assembly 60 generally consists of a motor and a transmission device (such as gears, belts, etc.). The motor works based on the instructions in the control signal, and drives the movable frame 50 to perform corresponding rotation via the transmission device. For example, if the control signal requires the movable frame 50 to rotate clockwise by a certain angle, the motor will rotate clockwise as instructed, and drive the movable frame 50 to rotate to the specified angle through gear transmission.

During the rotation of the movable frame 50 driven by the angle adjustment assembly 60, the center-of-gravity position of the gimbal 100 changes accordingly. The system continuously monitors the center-of-gravity position of the gimbal 100. When the center of gravity of the gimbal 100 enters the preset balance position or area, it indicates that the gimbal 100 has reached the center-of-gravity balance position, and the operation of the angle adjustment assembly 60 is stopped at this time.

Adjusting the center of gravity of the gimbal 100 itself before mounting the photographic device can ensure that the gimbal 100 is in a stable balance position in its initial state. This lays a solid foundation for the subsequent mounting of the photographic device and the implementation of automatic leveling, reduces the interference of the gimbal's own center-of-gravity imbalance on the leveling of the photographic device, and improves the efficiency and accuracy of the entire automatic leveling system.

Furthermore, by adjusting the center of gravity of the gimbal 100 itself, it is easier to achieve the overall center-of-gravity balance of the gimbal 100 when it carries the photographic device. Even after the photographic device is mounted, since the gimbal 100 itself is already in a good balance state, the adjustment range required for adjusting the center of gravity of the photographic device may be smaller. Thus, the overall center of gravity of the photographic device and the gimbal 100 can be adjusted to the balance position more quickly and accurately, further optimizing the leveling effect.

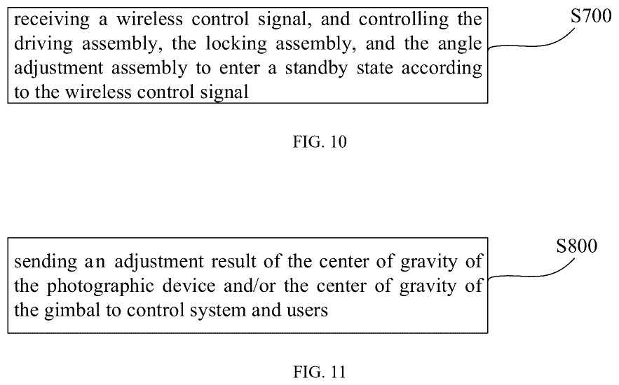

Please referring to FIGS. 10 and 11, in some embodiments, the gimbal 100 includes a wireless communication unit. Before performing all the steps, the method further includes:
Step S700, receiving a wireless control signal, and controlling the driving assembly 20, the locking assembly 30, and the angle adjustment assembly 60 to enter a standby state according to the wireless control signal.

After performing all the steps, the method further includes:
Step S800, sending an adjustment result of the center of gravity of the photographic device and/or the center of gravity of the gimbal 100 to control system and users. The wireless communication unit in the gimbal 100 is responsible for receiving the wireless control signal input by the user. Common wireless communication technologies include Wi-Fi, Bluetooth, ZigBee, etc. When the wireless communication unit receives the wireless control signal input by the user, the control system will, according to the signal instructions, control the driving assembly 20, the locking assembly 30, and the angle adjustment assembly 60 to enter a standby state. This eliminates the need for the user to manually operate each component of the gimbal 100, improving the convenience and efficiency of operation. The user can easily get the gimbal 100 ready for subsequent shooting through devices such as mobile phones while staying away from the gimbal 100.

It should be understood that for the driving assembly 20, the control system will stop sending driving signals to it, so that the driving assembly 20 ceases operation and enters a state ready to receive new instructions at any time. For the locking assembly 30, if it is in a locked state, the control system will release the lock according to the instruction, or maintain the current state but entering a low-power standby mode to wait for subsequent operation instructions. After receiving the standby instruction, the angle adjustment assembly 60 stops rotating, and the movable frame 50 remains in its current position, waiting for further subsequent operations. This ensures that before the gimbal 100 starts automatic leveling or other operations, all components are in a stable and controllable initial state.

After completing all automatic leveling steps, the control system of the gimbal 100 will collect the adjustment scheme regarding the center of gravity of the photographic device and/or the center of gravity of the gimbal 100. These schemes includes information such as whether the center of gravity has reached the balanced position, as well as the specific direction and magnitude of any adjustments. For example, based on sensor data and calculations performed by the control system, adjustments to the photographic device's center of gravity in the forward-backward and left-right directions are determined, along with verification of whether it finally falls within the preset balance zone. Similarly, for the center of gravity of the gimbal 100, its initial imbalance state, the adjustment process, and the final balanced condition are recorded. The control system then organizes this information into a format that is easy to understand and transmit. For instance, the adjustment schemes are encoded in the form of numbers, text, or charts, so that they can be sent to the user via the wireless communication unit. The user can then view prompt information on the mobile application interface indicating whether the centers of gravity of both the photographic device and the gimbal 100 are balanced, along with specific adjustment parameters. This enables the user to stay informed about the status of both the gimbal 100 and the photographic device timely.

Please continue to referring to FIG. 1, the embodiment of the present disclosure further provides a gimbal 100. The gimbal 100 includes a control device, a mounting assembly 10 for mounting a photographic device, and a driving assembly 20 connected to the mounting assembly 10 for driving the mounting assembly 10 to move. The control device includes a memory having computer-executable instructions stored thereon, and a processor coupled to the memory and configured to execute the computer-executable instructions to implement operations of the automatic leveling method for the gimbal 100.

A person skilled in the art can understand that all or part of the processes in the methods of the above embodiments can be completed by instructing the relevant hardware through computer-executable instructions. The computer-executable instructions can be stored in a non-volatile computer-readable storage medium and to be executed by a processor to implement operations of the automatic leveling method for the gimbal. Any reference to memory, storage, database, or other media provided in this application and used in the embodiments may include non-volatile and/or volatile memory. Non-volatile memory may include read-only memory (ROM), programmable read-only memory (PROM), electrically programmable read-only memory (EPROM), electrically erasable programmable read-only memory (EEPROM), or flash memory. Volatile memory may include random access memory (RAM) or external cache memory. By way of illustration and not limitation, RAM is available in various forms, such as static random access memory (SRAM), dynamic random access memory (DRAM), synchronous dynamic random access memory (SDRAM), double data rate synchronous dynamic random access memory (DDR SDRAM), enhanced synchronous dynamic random access memory (ESDRAM), synchlink dynamic random access memory (SLDRAM), rambus direct random access memory (RDRAM), direct memory bus dynamic random access memory (DRDRAM), and memory bus dynamic random access memory (RDRAM).

In some embodiments, the mounting assembly 10 includes a mounting base 11 and a carrying base 12 connected to the mounting base 11 for bearing the photographic device. The driving assembly 20 is disposed between the mounting base 11 and the carrying base 12 for driving the carrying base 12 to move horizontally relative to the mounting base 11.

In this embodiment, a layered design of the mounting base 11 and the carrying base 12 is employed, which facilitates the installation and adjustment of the photographic device. The mounting base 11 can serve as a fixed base part to achieve stable connection with other parts of the gimbal 100 (such as supports, bases, etc.). The carrying base 12 is configured for placing the photographic device, and can horizontally move relative to the mounting base 11 via the driving assembly 20, thus enabling effective fine adjustment of the horizontal position of the photographic device.

In some embodiments, the carrying base 12 and the mounting base 11 are connected by way of a horizontal plug-in structure 70, and the driving assembly 20 and the carrying base 12 are connected by way of a rack-and-pinion transmission structure 80.

The horizontal plug-in structure 70 is configured to realize the horizontal connection between the carrying base 12 and the mounting base 11. For example, sliding grooves of certain shapes are defined in the mounting base 11, and sliding blocks which matches the shapes and sizes of these sliding grooves are provided on the carrying base 12.

The horizontal plug-in structure 70 simplifies and speeds up the installation process of the carrying base 12 and the mounting base 11. Users only need to align the sliding blocks on the carrying base 12 with the sliding grooves in the mounting base 11 and then insert the sliding blocks horizontally to complete the connection, without the need of complex tools or cumbersome operations.

Thanks to the precise fit between the sliding grooves and the sliding blocks, the carrying base 12 can be accurately positioned on the mounting base 11 after installation, ensuring the positional accuracy of the photographic device post-installation. When the carrying base 12 or the mounting base 11 is damaged and needs repair or replacement, the horizontal plug-in structure 70 also facilitates easy disassembly. The carrying base 12 can simply be pulled out horizontally from the mounting base 11 for corresponding maintenance or replacement, reducing maintenance costs and time.

The rack-and-pinion transmission structure 80 serves as the power transmission between the driving assembly 20 and the carrying base 12. The driving assembly 20 generally includes a motor having an output shaft with a gear mounted thereon. Meanwhile, a rack meshing with the gear is arranged on the carrying base 12. When the motor is activated, its output shaft drives the gear to rotate. The gear and rack mesh with each other, converting the rotational motion of the gear into the linear motion of the rack, thereby driving the carrying base 12 to move horizontally.

In this embodiment, the rack-and-pinion transmission structure 80 achieves high transmission efficiency, effectively transferring the motor's power to the carrying base 12. Moreover, this structure is compact and occupies little space. This is highly beneficial to the overall structural design of the gimbal 100, enabling efficient power transmission and precise position control within a limited space. It also helps to reduce the overall weight of the gimbal 100 and improve its portability.

In some embodiments, the gimbal 100 further includes a locking assembly 30 for locking the carrying base 12 and the mounting base 11 together.

In this embodiment, the locking assembly 30 may adopt mechanical structures such as snap-fit locks or locking bolts. Utilizing its inherent shape and structural features, the locking assembly 30 engages the corresponding parts of the carrying base 12 and the mounting base 11 to form mechanical constraints, limiting relative movement and rotation between the two components, thus achieving locking. This ensures no relative displacement or loosening between the carrying base 12 and the mounting base 11, so as to maintain the stability of the photographic device's shooting position and angle, which is conducive to capturing high-quality and shake-free images.

In some embodiments, the gimbal 100 further includes a support frame 40 connected to the mounting assembly 10 and a movable frame 50 movably connected to the support frame 40. The gimbal 100 also includes an angle adjustment assembly 60 configured to drive the movable frame 50 to rotate.

The support frame 40 serves as the basic supporting structure of the gimbal 100. A tight connection between the support frame 40 and the mounting assembly 10 provides stable support for the entire gimbal 100 system. The support frame 40 is generally made of rigid metal materials such as aluminum alloy or steel to ensure sufficient strength and stability to bear the weight of the mounting assembly 10, the photographic device, and other related components.

The movable frame 50 is movably connected to the support frame 40, allowing the movable frame 50 to move within a certain range relative to the support frame 40. Common movable connection methods include rotational connection and pivotal connection. With rotational connection, the movable frame 50 can rotate around a fixed axis to achieve horizontal rotation; pivotal connection allows the movable frame 50 to swing at a certain angle in multiple directions, enhancing the flexibility and adjustability of the gimbal 100.

The above description is merely some embodiments. It should be noted that for one with ordinary skills in the art, improvements can be made without departing from the concept of the present disclosure, but these improvements shall fall into the protection scope of the present disclosure.

What is claimed is:

1. An automatic leveling method for a gimbal, wherein the gimbal comprises a mounting assembly for mounting a photographic device and a driving assembly connected to the mounting assembly and configured for driving the mounting assembly to move, and the method comprises:
obtaining a center of gravity of the photographic device and determining whether the center of gravity of the photographic device is in an unbalanced position in response to that the photographic device is mounted on the mounting assembly;
generating a control signal for adjusting the center of gravity of the photographic device in case the center of gravity of the photographic device is in the unbalanced position; and
controlling the driving assembly to operate according to the control signal to drive the mounting assembly to move until the photographic device reaches a center-of-gravity balance position.

2. The method according to claim 1, wherein the mounting assembly comprises:
a mounting base; and
a carrying base, connected to the mounting base and configured to carry the photographic device;
wherein the driving assembly is arranged between the mounting base and the carrying base and configured to drive the carrying base to move horizontally relative to the mounting base;
wherein the operation “controlling the driving assembly to operate according to the control signal to drive the mounting assembly to move until the photographic device reaches a center-of-gravity balance position” comprises:
controlling the driving assembly to operate according to the control signal to drive the carrying base to move forward and backward until the photographic device reaches the center-of-gravity balance position.

3. The method according to claim 2, wherein the operation “controlling the driving assembly to operate according to the control signal to drive the carrying base to move forward and backward until the photographic device reaches the center-of-gravity balance position” comprises:
in case the center of gravity of the photographic device c, controlling the driving assembly to operate according to the control signal to drive the carrying base to move backward until the photographic device reaches the center-of-gravity balance position; and
in case the center of gravity of the photographic device tilts backward, controlling the driving assembly to operate according to the control signal to drive the carrying base to move forward until the photographic device reaches the center-of-gravity balance position.

4. The method according to claim 2, wherein the gimbal further comprises a locking assembly for locking the carrying base with the mounting base, and the method further comprises:
controlling the locking assembly to operate to lock the carrying base with the mounting base after the photographic device reaches the center-of-gravity balance position.

5. The method according to claim 4, wherein the gimbal further comprises:
a support frame connected to the mounting assembly; and
a movable frame movably connected to the support frame;
wherein the operation “obtaining the center of gravity of the photographic device and determining whether the center of gravity of the photographic device is in the unbalanced position” comprises:
obtaining a tilt angle of the movable frame relative to the support frame, and determining whether the tilt angle is within a preset tilt angle range; and
determining a center-of-gravity offset direction of the photographic device according to the tilt angle in response to that the tilt angle exceeds the preset tilt angle range, and generating a control signal containing the determination.

6. The method according to claim 5, wherein the gimbal further comprises an angle adjustment assembly for driving the movable frame to rotate; and the method further comprises:
obtaining the center of gravity of the gimbal when no photographic device is mounted on the mounting assembly; and
generating a signal to control an operation of the angle adjustment assembly in case the center of gravity of the gimbal is in the unbalanced position until the gimbal reaches the center-of-gravity balance position.

7. The method according to claim 6, wherein the gimbal comprises a wireless communication unit;
before performing the operation “obtaining the center of gravity of the photographic device and determining whether the center of gravity of the photographic device is in an unbalanced position”, the method further comprises:
receiving a wireless control signal, and controlling the driving assembly, the locking assembly, and the angle adjustment assembly to enter a standby state according to the wireless control signal.

8. The method according to claim 7, wherein after the operation “generating a signal to control an operation of the angle adjustment assembly in case the center of gravity of the gimbal is in the unbalanced position until the gimbal reaches the center-of-gravity balance position”, the method further comprises:
sending an adjustment result of the center of gravity of the photographic device and/or the center of gravity of the gimbal to control system.

9. A gimbal, comprising:
a control device;
a mounting assembly configured for mounting a photographic device; and
a driving assembly, connected to the mounting assembly and configured for driving the mounting assembly to move;
wherein the control device comprises a memory having computer-executable instructions stored thereon, and a processor coupled to the memory and configured to execute the computer-executable instructions to implement operations of the automatic leveling method for the gimbal as claimed in claim 1.

10. The gimbal according to claim 9, wherein the mounting assembly comprises:
a mounting base; and
a carrying base, connected to the mounting base and configured for carrying the photographic device;
the driving assembly is arranged between the mounting base and the carrying base for driving the carrying base to move horizontally relative to the mounting base.

11. The gimbal according to claim 10, wherein the carrying base and the mounting base are connected by way of a horizontal plug-in structure; the driving assembly and the carrying base are connected by way of a rack-and-pinion transmission structure.

12. The gimbal according to claim 10, further comprising:
a locking assembly, configured for locking the carrying base with the mounting base.

13. The gimbal according to claim 10, further comprising:
a support frame, connected to the mounting assembly; and
a movable frame, movably connected to the support frame;
wherein the gimbal further comprises an angle adjustment assembly configured to drive the movable frame to rotate.
